(19) United States
(12) Patent Application Publication
(10) Pub. No.: US 2026/0111273 A1
(43) Pub. Date: Apr. 23, 2026

(54) SELF-DISCOVERY AND DEPLOYMENT IN EDGE APPLIANCE

(71) Applicant: Dell Products L.P., Round Rock, TX (US)

(72) Inventors: Genliu XING, Shanghai (CN); Charlie CHEN, Shanghai (CN); Hanzhang GU, Shanghai (CN); Honggang LIU, Shanghai (CN)

(73) Assignee: Dell Products L.P., Round Rock, TX (US)

(21) Appl. No.: 18/943,612

(22) Filed: Nov. 11, 2024

(30) Foreign Application Priority Data
Oct. 21, 2024 (CN) 202411471433.5

(51) Int. Cl. G06F 9/50

(52) U.S. Cl. CPC G06F 9/5027

(57) ABSTRACT

An information handling system cluster may include a chassis, a chassis manager (CM); and nodes, each node including a host processor and a baseboard management controller (BMC). Each node may be configured to: determine a set of operational information about that node; transmit the set of operational information from the host processor of that node to the BMC of that node; and transmit the set of operational information from the BMC of that node to the CM. A primary node may be configured to: receive operational information about other nodes of the plurality of nodes from the CM at the BMC of the primary node; transmit the operational information about the other nodes from the BMC of the primary node to the host processor of the primary node; and initialize the information handling system cluster based on the operational information about the other nodes.

### TECHNICAL FIELD

The present disclosure relates in general to information handling systems, and more particularly to discovery and deployment when setting up edge nodes of a computing cluster.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Automated discovery of new HCI nodes is important during the bring-up of a new cluster. However, existing service discovery protocols such as zero-configuration networking (zeroconf) usually rely on the broadcast or multicast capability in an IP network. Using such tools can be a challenge in some cases such as edge environments, because broadcast and/or multicast may be restricted or unavailable. Further, an edge environment may not have dedicated support personnel on site, and so a fully automated solution is desired.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with edge deployments may be reduced or eliminated.

In accordance with embodiments of the present disclosure, an information handling system cluster may include a chassis, a chassis manager (CM); and nodes, each node including a host processor and a baseboard management controller (BMC). Each node may be configured to: determine a set of operational information about that node; transmit the set of operational information from the host processor of that node to the BMC of that node; and transmit the set of operational information from the BMC of that node to the CM. A primary node may be configured to: receive operational information about other nodes of the plurality of nodes from the CM at the BMC of the primary node; transmit the operational information about the other nodes from the BMC of the primary node to the host processor of the primary node; and initialize the information handling system cluster based on the operational information about the other nodes.

In accordance with these and other embodiments of the present disclosure, a method may include in information handling system cluster comprising a chassis, a chassis manager (CM), and a plurality of nodes within the chassis, each node including a host processor and a baseboard management controller (BMC): each node of the plurality of nodes determining a set of operational information about that node; each node transmitting the set of operational information from the host processor of that node to the BMC of that node; each node transmitting the set of operational information from the BMC of that node to the CM; a primary node of the plurality of nodes receiving operational information about other nodes of the plurality of nodes from the CM at the BMC of the primary node; the primary node transmitting the operational information about the other nodes from the BMC of the primary node to the host processor of the primary node; and the primary node initializing the information handling system cluster based on the operational information about the other nodes.

In accordance with these and other embodiments of the present disclosure, an article of manufacture may include a non-transitory, computer-readable medium having computer-executable instructions thereon that are executable by an information handling system cluster including a chassis, a chassis manager (CM), and a plurality of nodes within the chassis, each node including a host processor and a baseboard management controller (BMC), wherein the instructions are executable for: each node of the plurality of nodes determining a set of operational information about that node; each node transmitting the set of operational information from the host processor of that node to the BMC of that node; each node transmitting the set of operational information from the BMC of that node to the CM; a primary node of the plurality of nodes receiving operational information about other nodes of the plurality of nodes from the CM at the BMC of the primary node; the primary node transmitting the operational information about the other nodes from the BMC of the primary node to the host processor of the primary node; and the primary node initializing the information handling system cluster based on the operational information about the other nodes.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example process flow method, in accordance with embodiments of the present disclosure.

### DETAILED DESCRIPTION

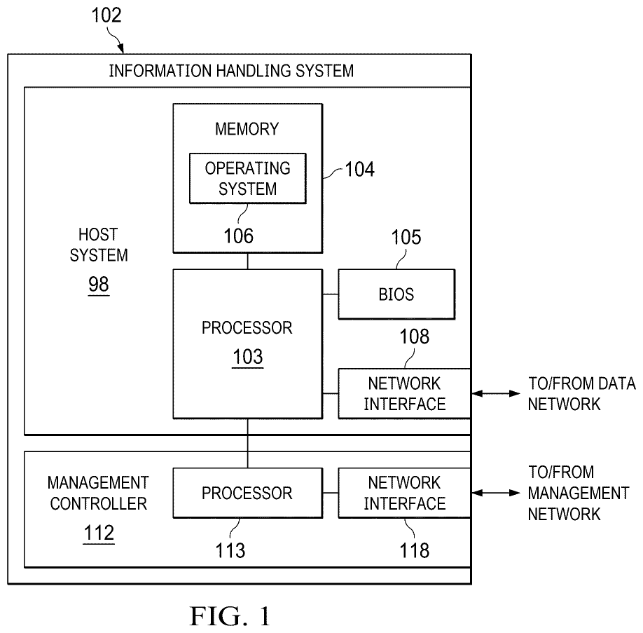

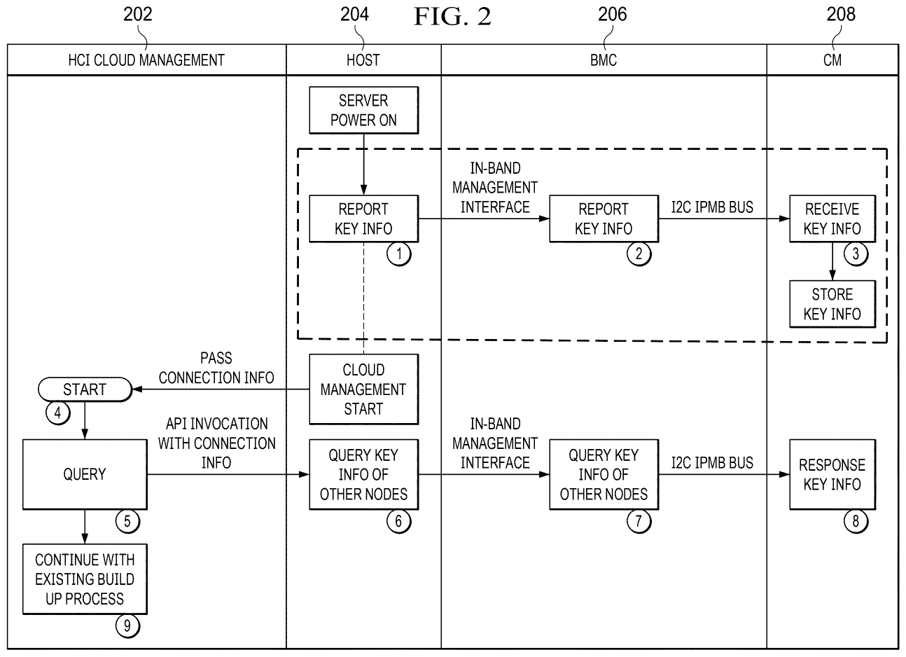

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in setting up nodes of information handling system 102 (e.g., edge nodes in an HCI deployment). Edge devices are generally the physical devices that are deployed at the edge of the network, such as internet-of-things (IoT) devices, edge gateways, edge servers, etc. It should be noted that while the scenario of an edge deployment is discussed in detail herein for the sake of concreteness, other embodiments are also specifically contemplated within the scope of this disclosure.

In some cases, an information handling system 102 may include more than one management controller 112. For example, when multiple host systems are present within a single chassis, each host may include a baseboard management controllers (BMC), which may provide management at the level of individual hosts or nodes. The chassis itself may include a chassis manager (CM) separate from the hosts, which may provide management at the chassis level. For example, the CM may control the hardware related to the chassis, such as the power supplies, fans, etc.

At a high level, embodiments of this disclosure may rely on the host itself, as well as a CM, a BMC, and an HCI cloud management platform, which may run on one or more nodes of an HCI cluster. When each host is powered on, it may report certain key information about itself (e.g., its IP address) to its BMC, which may then report that information to the CM. The host may also have the ability to query the CM for information about the other hosts in the chassis (e.g., with the BMC as intermediary again). Once the CM has collected information from all nodes, the cluster may be built up using that information.

Turning now to FIG. 2, an example sequence diagram method is shown, according to some embodiments.

When the server is first powered on, each host 204 may report its key information (e.g., including its IP address) to its BMC 206. The BMCs 206 may then pass that information to CM 208. Host 204 may communicate with its BMC via an in-band management interface (e.g., keyboard controller style (KCS), Bluetooth, or an internal USB NIC) in some embodiments. BMC 206 and CM 208 may communicate via an I2C Intelligent Platform Management Bus (IPMB) in some embodiments.

In some embodiments, a primary node may be elected to manage the cluster initialization process. In some cases, the primary node may be the node with the smallest serial number or the like. Other methods for primary node election are also used in some embodiments.

Once a primary node for the HCI cluster has been selected, HCI cloud management software 202 may run on the primary host 204 (e.g., within a VM) once the primary host 204 starts up. HCI cloud management software 202 may query the primary node's BMC 206 regarding IP addresses for all of the other discovered nodes in the chassis. BMC 206 may communicate with CM 208 in order to respond to this query.

Based on the IP address information returned from this query, HCI cloud management software 202 may directly query any other necessary information from the other nodes in order to continued building up the cluster. In some embodiments, this process may take place using the nodes' link-local IPv6 addresses without the need for a dynamic host configuration protocol (DHCP) server or the like.

After the HCI cloud management software 202 receives all the needed other information to build up the cluster, existing processes for cluster initialization may be used to finalize the new cluster.

One of ordinary skill in the art with the benefit of this disclosure will understand that the preferred initialization point for the method depicted in FIG. 2 and the order of the steps comprising that method may depend on the implementation chosen. In these and other embodiments, these method may be implemented as hardware, firmware, software, applications, functions, libraries, or other instructions. Further, although FIG. 2 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system cluster comprising:
a chassis;
a chassis manager (CM); and
a plurality of nodes within the chassis, wherein each node includes a host processor and a baseboard management controller (BMC);
wherein each node of the plurality of nodes is configured to:
determine a set of operational information about that node;
transmit the set of operational information from the host processor of that node to the BMC of that node; and
transmit the set of operational information from the BMC of that node to the CM; and
wherein a primary node of the plurality of nodes is configured to:
receive operational information about other nodes of the plurality of nodes from the CM at the BMC of the primary node;
transmit the operational information about the other nodes from the BMC of the primary node to the host processor of the primary node; and
initialize the information handling system cluster based on the operational information about the other nodes.

2. The information handling system cluster of claim 1, wherein the set of operational information includes an internet protocol (IP) address.

3. The information handling system cluster of claim 2, wherein the IP address is an IPv6 link-local address.

4. The information handling system cluster of claim 3, wherein the information handling system cluster is not communicatively coupled to a dynamic host configuration protocol (DHCP) server.

5. The information handling system cluster of claim 1, wherein the information handling system cluster is a hyper-converged infrastructure (HCI) cluster.

6. The information handling system cluster of claim 1, wherein the information handling system cluster is an edge deployment.

7. A method comprising, in information handling system cluster comprising a chassis, a chassis manager (CM), and a plurality of nodes within the chassis, each node including a host processor and a baseboard management controller (BMC):
each node of the plurality of nodes determining a set of operational information about that node;
each node transmitting the set of operational information from the host processor of that node to the BMC of that node;
each node transmitting the set of operational information from the BMC of that node to the CM;
a primary node of the plurality of nodes receiving operational information about other nodes of the plurality of nodes from the CM at the BMC of the primary node;
the primary node transmitting the operational information about the other nodes from the BMC of the primary node to the host processor of the primary node; and
the primary node initializing the information handling system cluster based on the operational information about the other nodes.

8. The method of claim 7, wherein the set of operational information includes an internet protocol (IP) address.

9. The method of claim 8, wherein the IP address is an IPv6 link-local address.

10. The method of claim 9, wherein the information handling system cluster is not communicatively coupled to a dynamic host configuration protocol (DHCP) server.

11. The method of claim 7, wherein the information handling system cluster is a hyper-converged infrastructure (HCI) cluster.

12. The method of claim 7, wherein the information handling system cluster is an edge deployment.

13. An article of manufacture comprising a non-transitory, computer-readable medium having computer-executable instructions thereon that are executable by an information handling system cluster including a chassis, a chassis manager (CM), and a plurality of nodes within the chassis, each node including a host processor and a baseboard management controller (BMC), wherein the instructions are executable for:
each node of the plurality of nodes determining a set of operational information about that node;
each node transmitting the set of operational information from the host processor of that node to the BMC of that node;
each node transmitting the set of operational information from the BMC of that node to the CM;
a primary node of the plurality of nodes receiving operational information about other nodes of the plurality of nodes from the CM at the BMC of the primary node;
the primary node transmitting the operational information about the other nodes from the BMC of the primary node to the host processor of the primary node; and
the primary node initializing the information handling system cluster based on the operational information about the other nodes.

14. The article of manufacture of claim 13, wherein the set of operational information includes an internet protocol (IP) address.

15. The article of manufacture of claim 14, wherein the IP address is an IPv6 link-local address.

16. The article of manufacture of claim 15, wherein the information handling system cluster is not communicatively coupled to a dynamic host configuration protocol (DHCP) server.

17. The article of manufacture of claim 13, wherein the information handling system cluster is a hyper-converged infrastructure (HCI) cluster.

18. The article of manufacture of claim 13, wherein the information handling system cluster is an edge deployment.
